(19) United States
(12) Patent Application Publication
(10) Pub. No.: US 2012/0103115 A1
(43) Pub. Date: May 3, 2012

(54) NUT ROTARY BALL SCREW WITH A PREDETERMINED PRESSURE STRUCTURE

(75) Inventors: Wen-Chia Wu, Taichung Industrial Park (TW); Xin-He Chen, Taichung Industrial Park (TW)

(73) Assignee: HIWIN TECHNOLOGIES CORP

(21) Appl. No.: 12/914,943

(22) Filed: Oct. 28, 2010

(51) Int. Cl. F16H 25/12

(52) U.S. Cl. 74/89.23

(57) ABSTRACT

A nut rotary ball screw with a predetermined pressure structure is disclosed. In the nut rotary ball screw of the present invention, we may rotate the predetermined pressure adjusting device to adjust the magnitude of the predetermined pressure by generating a predetermined pressure between the first inner slot and the outer slot as well as the first rolling pieces and between the second inner slot and the outer slot as well as the first rolling pieces. The present invention can greatly simplify the complicated adjustment process of the predetermined pressure in the prior art and can eliminate the time-consuming grinding step and the steps to disassemble or assemble a bolt. Accordingly, the present may simplify the adjustment process of the predetermined pressure and may lower the production cost.

### BACKGROUND OF THE INVENTION

1. Field of the Invention

The invention generally relates to a linear transmission device. More particularly, the invention relates to a nut rotary ball screw with a predetermined pressure structure.

2. Description of the Related Art

Please refer to FIG. 1, which illustrates a conventional nut rotary ball screw 90. The conventional nut rotary ball screw 90 comprises a shaft portion, a nut portion 91, a first bearing sleeve 92 and a second bearing sleeve 93. The nut portion 91 has a central hole, which allows the passage of the shaft portion. Two slots 911 and 912 are provided on the outer surface of the nut portion 91 to hold the first bearing sleeve 92, a predetermined pressure piece 95 and the second bearing sleeve 93. A first slot 921 is provided on the first bearing sleeve 92 and a second slot 931 is provided on the second bearing sleeve 93. A plurality of rolling pieces 94 are held between the first slot 921 and the slot 911 and between the first slot 921 and the slot 912. The rolling pieces 94 facilitate the relative movement between the first bearing sleeve 92, the second bearing sleeve 93 and the nut portion 91. In addition, a first flange 922 is provided on the first bearing sleeve 92 and a second flange 932 is provided on the second bearing sleeve 93. A plurality of first fisheye holes 923 are provided on the first flange 922 and a plurality of second fisheye holes 933 are provided on the second flange 932. The predetermined pressure piece 95 is disposed between the first bearing sleeve 92 and the second bearing sleeve 93. A hole 951 is provided to make each of the first fisheye holes 923 in communication with the corresponding second fisheye hole 933. A bolt may be held in the space formed by a first fisheye hole 923, the corresponding second fisheye hole 933 and the hole 951. As the bolt is tightened, a predetermined pressure X in the left direction would be generated on the first bearing sleeve 92 and a predetermined pressure Y in the right direction would be generated on the second bearing sleeve 93; in the mean time, a pressure would be generated between the rolling pieces 94 and the first slot 921 as well as the rolling pieces 94 and the slot 911 and between the rolling pieces 94 and the second slot 931 as well as the rolling pieces 94 and the slot 911. Therefore, the predetermined pressure may be adjusted. However, the conventional nut rotary ball screw 90 has the following disadvantages:
1. In order to adjust the magnitude of the predetermined pressure, the predetermined pressure piece needs to be taken out and hence the relevant components need to be disassembled (at least three sets of bolts need to be loosened). Afterwards, the relevant components need to be assembled. This raises the cost in operation.
2. Most components are fixed by a flange portion, which comprises the predetermined pressure piece, a first flange and a second flange. Therefore, such flange portion is thicker than an integrally formed flange. If the thickness of the flange portion is reduced by grinding, the thickness of the first fisheye holes and the second fisheye holes would be reduced and hence the rigidity of the flange and the entire nut rotary ball screw would be lowered. Therefore, the nut rotary ball screw would then be prone to damages.

### SUMMARY OF THE INVENTION

From the above, we can see that the conventional nut rotary ball screw has many disadvantages and need to be improved. To eliminate the disadvantages in the prior art, the inventor has put a lot of effort into the subject and has successfully come up with the nut rotary ball screw of the present invention.

An object of the present invention is to provide a nut rotary ball screw with a predetermined pressure structure that may be adjusted easily.

Another object of the present invention is to provide a flange, which is a component of the nut rotary ball screw and is integrally formed.

To reach these objects, the nut rotary ball screw with a predetermined pressure structure of the present invention is disclosed. The nut rotary ball screw of the present invention comprises a shaft portion, a nut portion, a backflow element, a bearing sleeve portion and a bearing sleeve portion.

The shaft portion is cylindrical. An inner spiral thread is provided on the outer surface of the shaft portion.

The nut portion has a central hole, which allows the passage of the shaft portion. An outer spiral thread, which matches the inner spiral thread, is provided on the wall of the central hole. The inner spiral thread and the outer spiral thread form a path and an outer slot and an outer thread are provided on the outer surface of the nut portion. Two backflow holes, which extend axially through the nut portion, are provided on the nut portion.

The backflow element is fitted to the nut portion. The backflow element has several backflow slots, which connect with the load path and the backflow holes. A circulatory path is formed by the load path, backflow holes and backflow slots. The circulatory path has a plurality of second rolling pieces.

The bearing sleeve portion is circular. A first inner slot and a second inner slot are provided on the inner surface of the bearing sleeve portion. The first inner slot and the outer slot forms a path, which can hold a plurality of first rolling pieces. A flange is provided on the outer surface of the bearing sleeve portion.

The predetermined pressure adjusting device is circular. An outer slot is provided on the outer surface of the predetermined pressure adjusting device. The outer slot and the second inner slot forms a path, which can hold a plurality of first rolling pieces. An inner thread is provided on the inner surface of the predetermined pressure adjusting device. The inner thread may engage with the outer thread so that the predetermined pressure adjusting device may be fitted to the nut portion. The rotation of the outer thread relative to the inner thread may prompt the predetermined pressure adjusting device to move in the H (axial) direction. As the predetermined pressure adjusting device moves towards the first rolling pieces, such movement would generate a predetermined pressure (Z) between the first inner slot and the outer slot as well as the first rolling pieces and between the second inner slot and the outer slot as well as the first rolling pieces. As the predetermined pressure adjusting device moves away from the first rolling pieces, such movement would reduce the predetermined pressure (Z). Therefore, rotating the predetermined pressure adjusting device can adjust the magnitude of the predetermined pressure (Z).

In the second embodiment of the present invention, the predetermined pressure adjusting device comprises a main body and an adjusting portion. An outer slot is provided on the outer surface of the main body. An inner thread is provided on the inner surface of the adjusting portion. The main body may be fitted to the nut portion and may be moved in the axial direction. The inner thread may engage with the outer thread. The rotation of the outer thread may prompt the adjusting portion to move in the axial (H) direction. As the predetermined pressure adjusting device moves towards the first rolling pieces, such movement would generate a predetermined pressure (Z) between the first inner slot and the outer slot as well as the first rolling pieces and between the second inner slot and the outer slot as well as the first rolling pieces. As the predetermined pressure adjusting device moves away from the first rolling pieces, such movement would reduce the predetermined pressure (Z). Therefore, rotating the predetermined pressure adjusting device can adjust the magnitude of the predetermined pressure (Z).

To enhance the positioning effect of the predetermined pressure adjusting device, two holes, which are radially opposing each other, are provided on the predetermined pressure adjusting device. A positioning piece may be held in each of the two holes. When the predetermined pressure (Z) is adjusted to the intended value, we can fit the two positioning pieces to the two holes and friction would be generated by the contact between the positioning pieces and the outer thread. Therefore, the predetermined pressure adjusting device would not become loose and the predetermined pressure (Z) may be maintained during operation.

The nut rotary ball screw of the present invention has the following advantages:

The complicated adjustment process of the predetermined pressure in the prior art may be greatly simplified. Several time-consuming steps, such as grinding and the unfastening and fastening of the bolts, may be eliminated. In addition, in the nut rotary ball screw of the present invention, the flange is integrally formed and is provided on the bearing sleeve portion. Therefore, flanges with different thicknesses may be used in the nut rotary ball screw of the present invention.

### BRIEF DESCRIPTION OF THE DRAWINGS

The drawings disclose two illustrative embodiments of the present invention which serve to exemplify the various advantages and objects hereof, and are as follows:

FIG. 1 is a conventional sectional view showing a nut rotary ball screw.

FIG. 2 is an exploded view showing a first embodiment of the present invention.

FIG. 2A is a partially enlarged view of FIG. 2.

FIG. 3 is a perspective view showing the first embodiment of the present invention in an assembled condition.

FIG. 4 is a sectional view along the line A-A in FIG. 3.

FIG. 4A is a partially enlarged view of FIG. 4.

FIG. 5 is a sectional view along the line B-B in FIG. 3.

FIG. 5A is a partially enlarged view of FIG. 5.

FIG. 6 is an exploded view showing a second embodiment of the present invention.

FIG. 7 is a perspective view showing the second embodiment of the present invention in an assembled condition.

FIG. 8 is a sectional view along the line C-C in FIG. 7.

FIG. 8A is a partially enlarged view of FIG. 8.

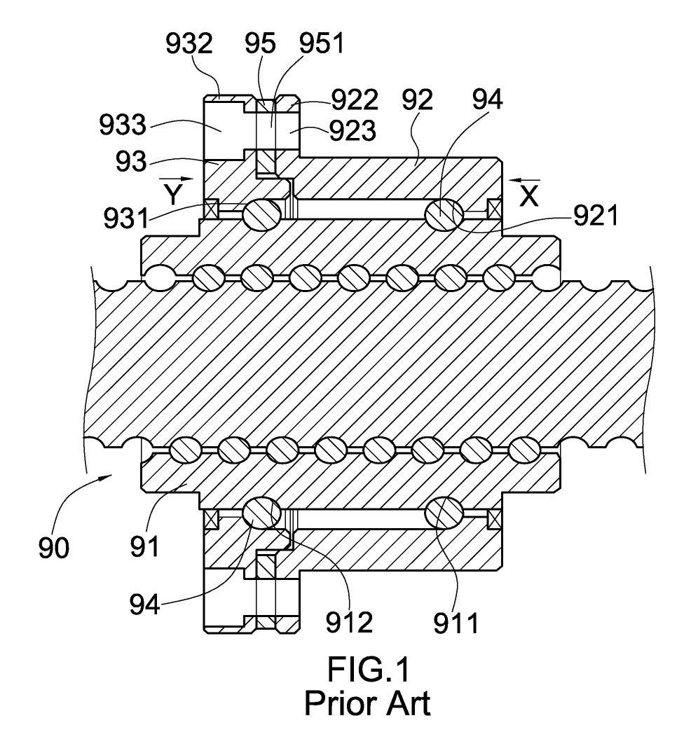

### DETAILED DESCRIPTION OF THE PREFERRED EMBODIMENTS

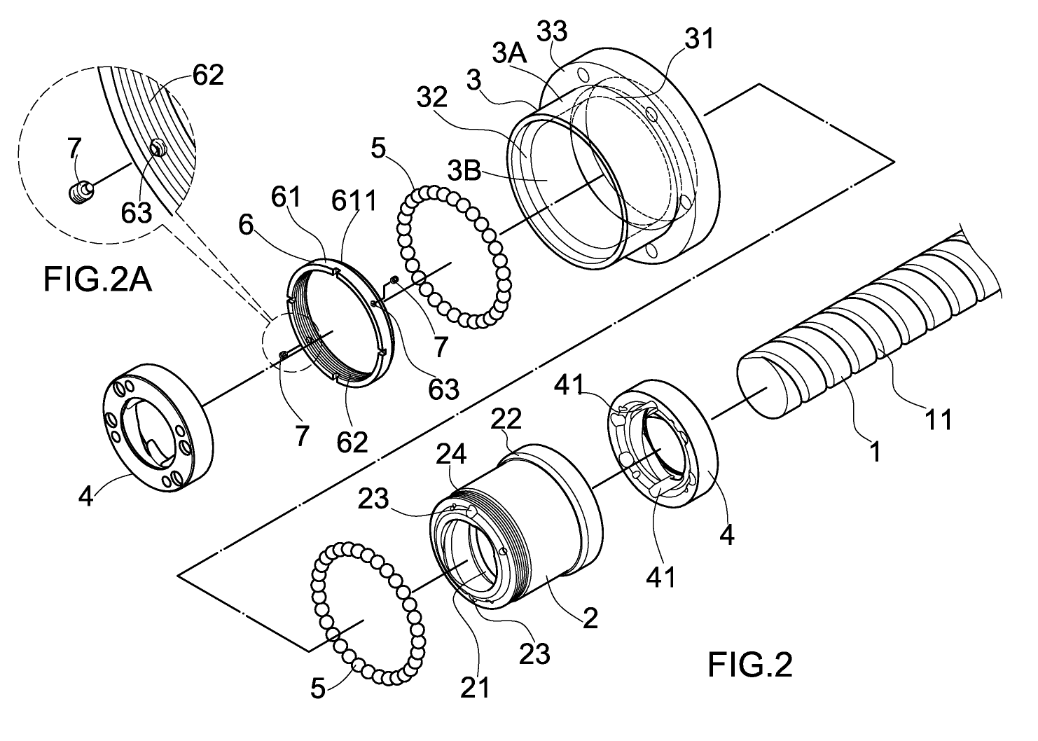

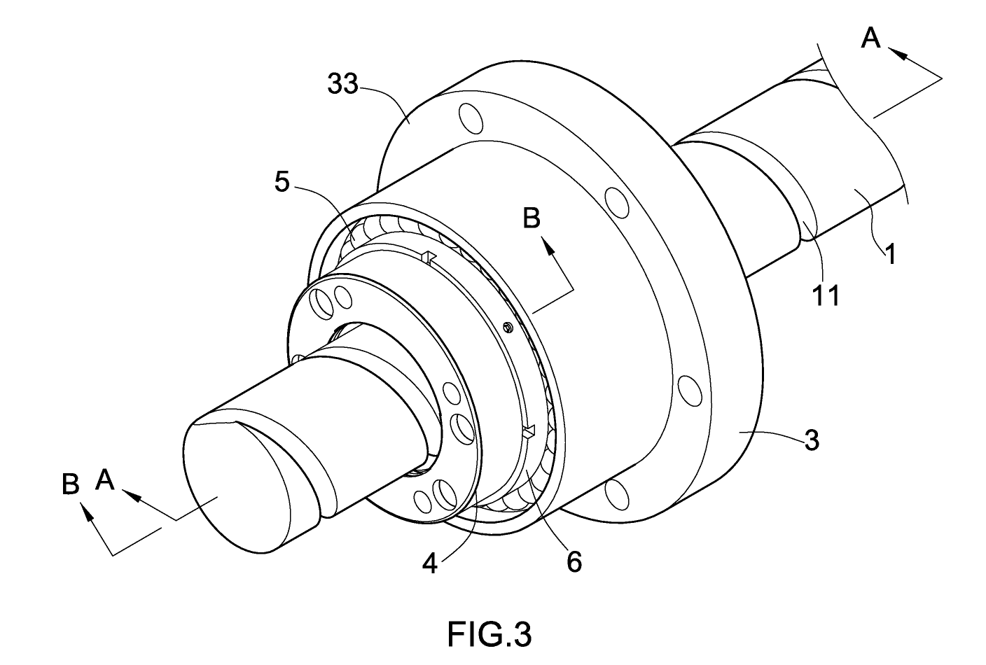

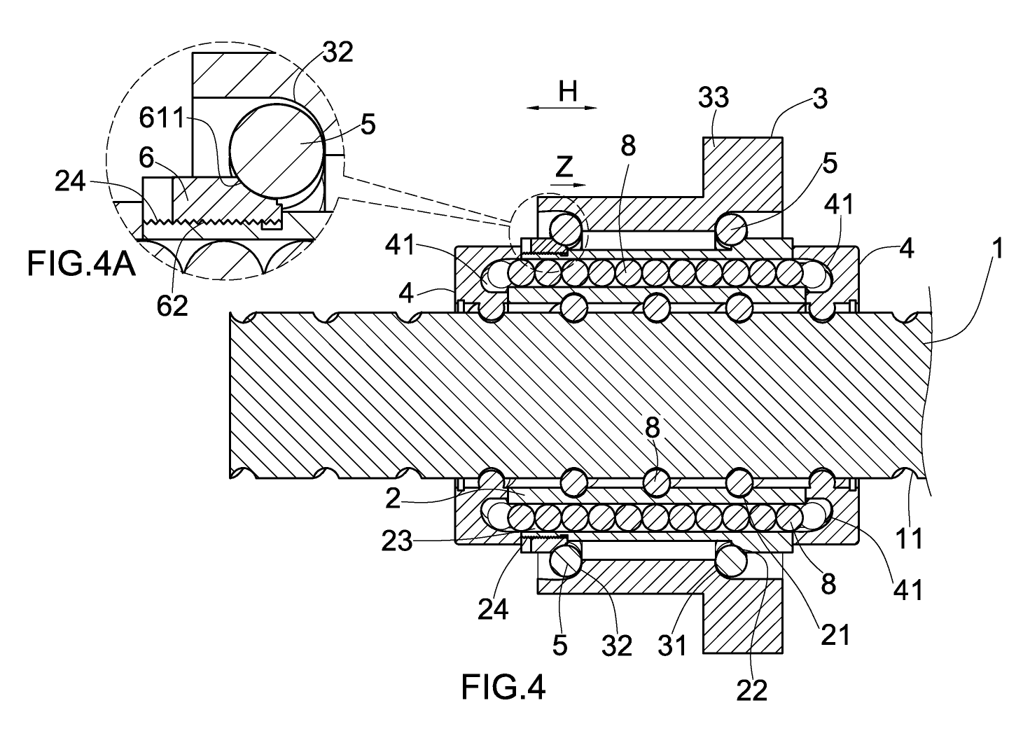

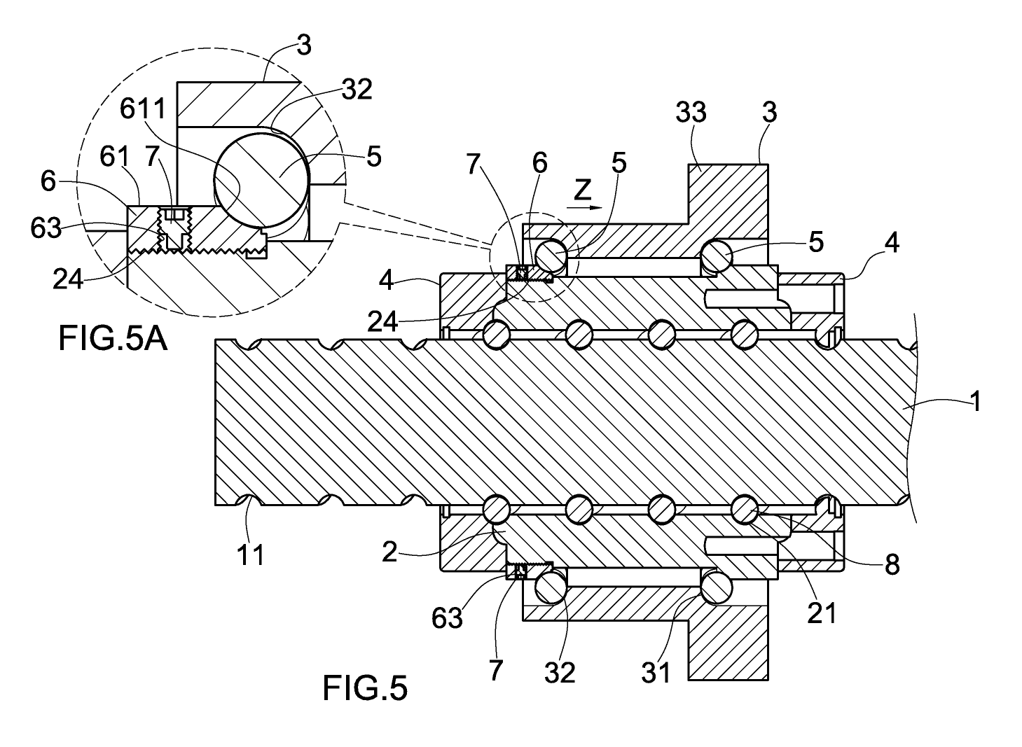

Please refer to FIGS. 2 to 5, which illustrate a first embodiment of the present invention. The nut rotary ball screw of the present invention comprises a shaft portion 1, a nut portion 2, a backflow element 4, a bearing sleeve portion 3, a predetermined pressure adjusting device 6.

The shaft portion 1 is cylindrical and an inner spiral thread 11 is provided on the outer surface of the shaft portion 1.

The nut portion 2 has a central hole, which allows the passage of the shaft portion 1. An outer spiral thread 21, which matches the inner spiral thread 11, is provided on the wall of the central hole. The inner spiral thread 11 and the outer spiral thread 21 form a path. An outer slot 22 and an outer thread 24 are provided on the outer surface of the nut portion 2. Two backflow holes, which extend axially through the nut portion 2, are provided on the nut portion 2.

The backflow element 4 is fitted to the nut portion 2. The backflow element 4 has several backflow slots 41, which connect with the load path and the backflow holes 23. A circulatory path is formed by the load path, backflow holes 23 and backflow slots 41. The circulatory path has a plurality of second rolling pieces 8.

The bearing sleeve portion 3 is circular. A first inner slot 31 and a second inner slot 32 are provided on the inner surface 3B of the bearing sleeve portion 3. The first inner slot 31 and the outer slot 22 forms a path, which can hold a plurality of first rolling pieces 5. A flange 33 is provided on the outer surface 3A of the bearing sleeve portion 3.

The predetermined pressure adjusting device 6 is circular. An outer slot 611 is provided on the outer surface 61 of the predetermined pressure adjusting device 6. The outer slot 611 and the second inner slot 32 forms a path, which can hold a plurality of first rolling pieces 5. An inner thread 62 is provided on the inner surface of the predetermined pressure adjusting device 6. The inner thread 62 may engage with the outer thread 24 so that the predetermined pressure adjusting device 6 may be fitted to the nut portion 2. Rotating the outer thread 24 may prompt the predetermined pressure adjusting device 6 to move in the H direction. As the predetermined pressure adjusting device 6 moves towards the first rolling pieces 5, such movement would generate a predetermined pressure Z between the first inner slot 31 and the outer slot 22 as well as the first rolling pieces 5 and between the second inner slot 32 and the outer slot 611 as well as the first rolling pieces 5. As the predetermined pressure adjusting device 6 moves away from the first rolling pieces 5, such movement would reduce the predetermined pressure Z. Therefore, rotating the predetermined pressure adjusting device 6 can adjust the magnitude of the predetermined pressure Z.

To enhance the positioning effect of the predetermined pressure adjusting device 6, two holes 63, which are radially opposing each other, are provided on the predetermined pressure adjusting device 6. A positioning piece 7 may be held in each of the two holes 63. When the predetermined pressure Z is adjusted to the intended value, we can fit the two positioning pieces 7 to the two holes 63 and friction would be generated by the contact between the positioning pieces 7 and the outer thread 24. Therefore, the predetermined pressure adjusting device 6 would not become loose and the predetermined pressure Z may be maintained during operation.

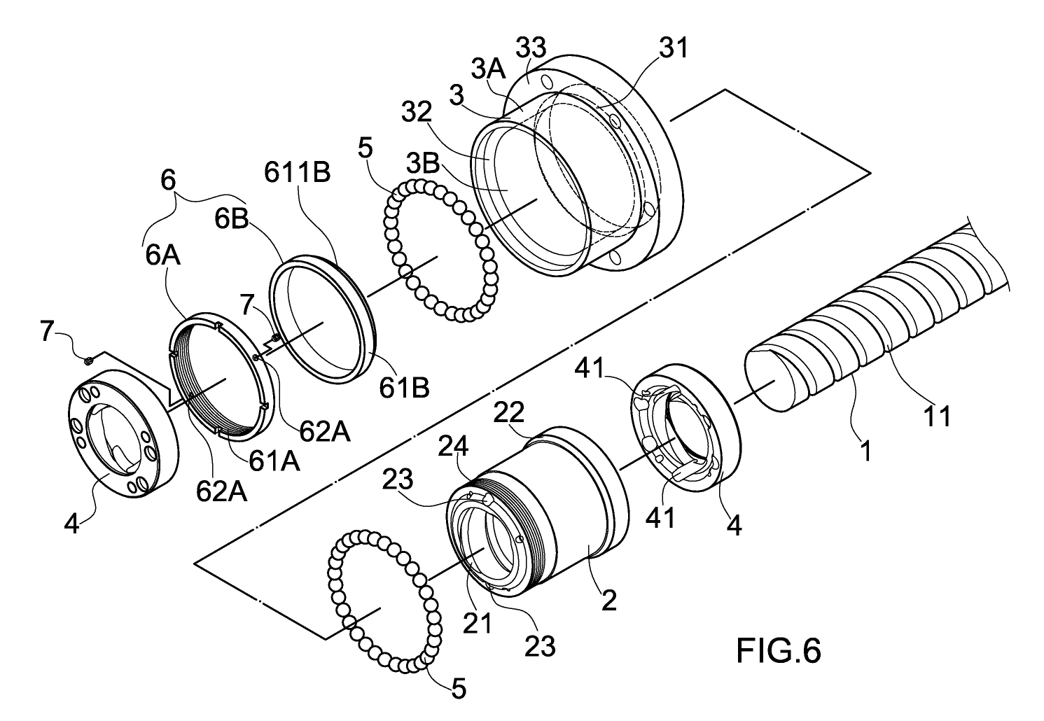

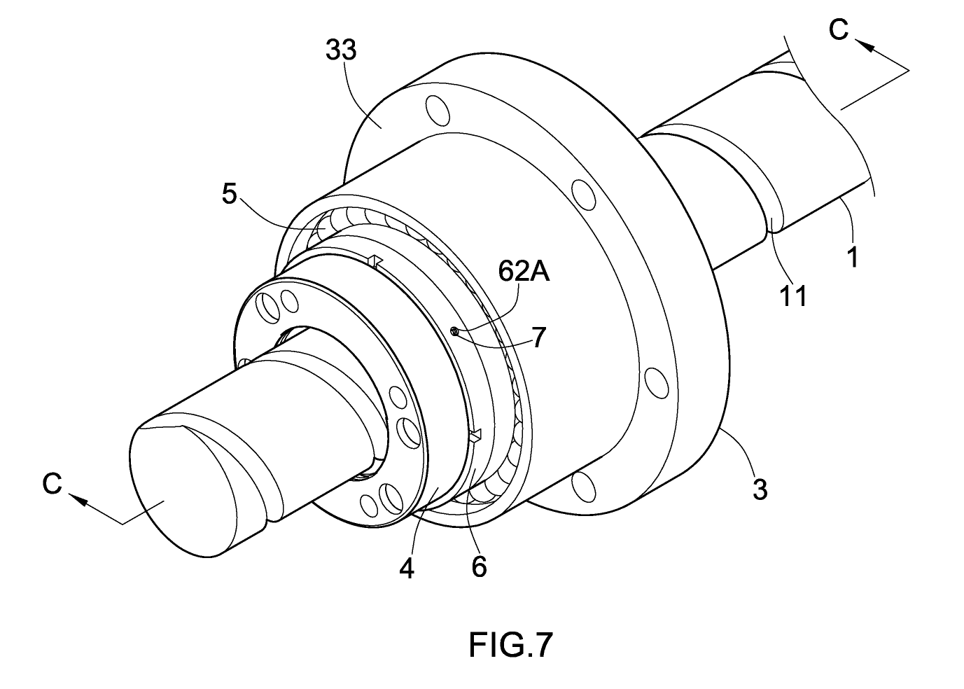

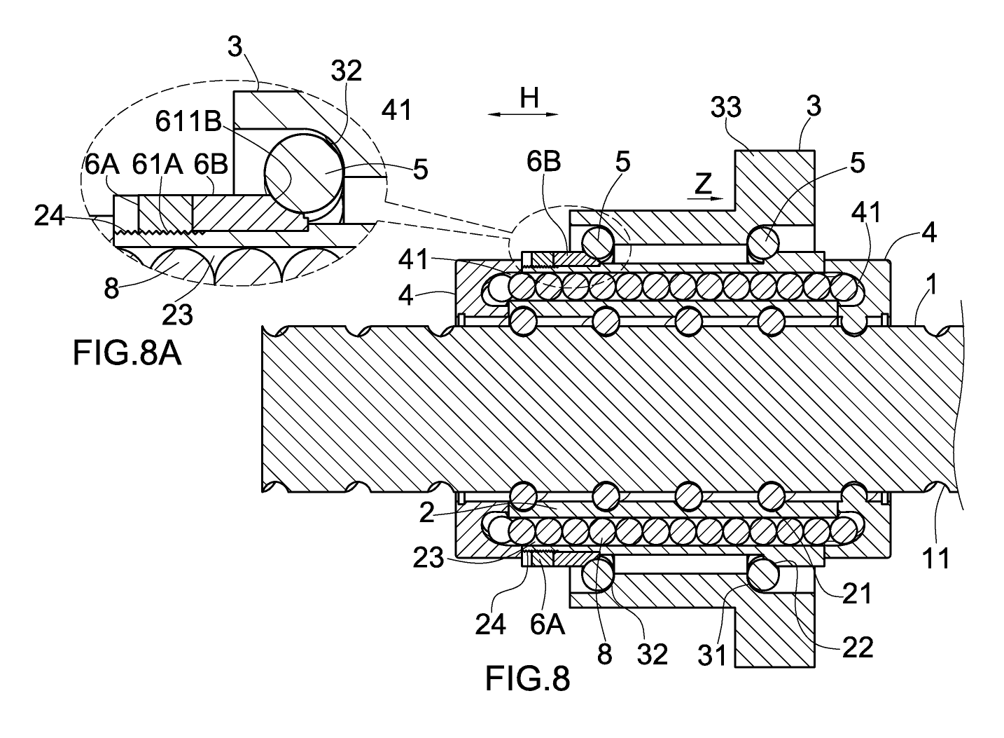

Please see FIGS. 6 to 8, which illustrate a second embodiment of the present invention. We will elaborate on how the second embodiment differs from the first embodiment in the following. The predetermined pressure adjusting device 6 comprises a main body 6B and an adjusting portion 6A. An outer slot 611B is provided on the outer surface 61B of the main body 6B. The outer slot 611B and the second inner slot 32 forms a path, which can hold the first rolling pieces 5. The main body 6B may be fitted to the nut portion 2 and may be moved in the axial direction. An inner thread 61A is provided on the inner surface of the adjusting portion 6A. The inner thread 61A may engage with the outer thread 24. Rotating the outer thread 24 may prompt the adjusting portion 6A to move in the H direction. As the predetermined pressure adjusting device 6 moves towards the first rolling pieces 5, such movement would generate a predetermined pressure Z between the first inner slot 31 and the outer slot 22 as well as the first rolling pieces 5 and between the second inner slot 32 and the outer slot 611B as well as the first rolling pieces 5. As the predetermined pressure adjusting device 6 moves away from the first rolling pieces 5, such movement would reduce the predetermined pressure Z. Therefore, rotating the predetermined pressure adjusting device 6 can adjust the magnitude of the predetermined pressure Z.

Similar to the first embodiment, holes 62A may be provided on the predetermined pressure adjusting device 6 and each of the holes 62A may hold a positioning piece 7 so that the predetermined pressure adjusting device 6 would not become loose and the predetermined pressure Z may be maintained during operation.

As previously described, the complicated adjustment process of the predetermined pressure in the prior art may be greatly simplified. Several time-consuming steps, such as grinding and the unfastening and fastening of the bolts, may be eliminated. In addition, in the nut rotary ball screw of the present invention, the flange is integrally formed and is provided on the bearing sleeve portion. Therefore, flanges with different thicknesses may be used in the nut rotary ball screw of the present invention.

The present invention is a high level technical creation and by no means simply utilizes conventional technology or knowledge known prior to the current patent application or can be easily made by persons skilled in the arts. The invention has not been published or put to public use or displayed in an exhibition. Therefore, the patent application of the present invention should be approved.

Many changes and modifications in the above described embodiment of the invention can, of course, be carried out without departing from the scope thereof. Accordingly, to promote the progress in science and the useful arts, the invention is disclosed and is intended to be limited only by the scope of the appended claims.

What is claimed is:

1. A nut rotary ball screw, comprising:
a shaft portion, which is cylindrical, wherein an inner spiral thread is provided on the outer surface of the shaft portion;
a nut portion, having a central hole, which allows the passage of the shaft portion, wherein an outer spiral thread, which matches the inner spiral thread, is provided on the wall of the central hole, and wherein the inner spiral thread and the outer spiral thread form a path, and wherein an outer slot and an outer thread are provided on the outer surface of the nut portion;
a backflow element, fitted to the nut portion;
a bearing sleeve portion, which is circular, wherein a first inner slot and a second inner slot are provided on the inner surface of the bearing sleeve portion, and wherein the first inner slot and the outer slot forms a path, which can hold a plurality of first rolling pieces; and
a predetermined pressure adjusting device, which is circular, wherein an outer slot is provided on the outer surface of the predetermined pressure adjusting device, and wherein the outer slot and the second inner slot forms a path, which can hold a plurality of first rolling pieces, and an inner thread is provided on the inner surface of the predetermined pressure adjusting device, and wherein the inner thread may engage with the outer thread so that the predetermined pressure adjusting device may be fitted to the nut portion, and wherein rotating the outer thread relative to the inner thread may prompt the predetermined pressure adjusting device to move in the axial direction, and wherein as the predetermined pressure adjusting device moves towards the first rolling pieces, such movement would generate a predetermined pressure (Z) between the first inner slot and the outer slot as well as the first rolling pieces and between the second inner slot and the outer slot as well as the first rolling pieces.

2. A nut rotary ball screw, comprising:
a shaft portion, which is cylindrical, wherein an inner spiral thread is provided on the outer surface of the shaft portion;
a nut portion, having a central hole, which allows the passage of the shaft portion, wherein an outer spiral thread, which matches the inner spiral thread, is provided on the wall of the central hole, and wherein the inner spiral thread and the outer spiral thread form a path, and wherein an outer slot and an outer thread are provided on the outer surface of the nut portion;
a backflow element, fitted to the nut portion;
a bearing sleeve portion, which is circular, wherein a first inner slot and a second inner slot are provided on the inner surface of the bearing sleeve portion, and wherein the first inner slot and the outer slot forms a path, which can hold a plurality of first rolling pieces; and
a predetermined pressure adjusting device, comprising a main body and an adjusting portion, wherein an outer slot is provided on the outer surface of the main body, and wherein the outer slot and the second inner slot forms a path, which can hold the first rolling pieces, and wherein the main body may be fitted to the nut portion and may be moved in the axial direction, and wherein an inner thread is provided on the inner surface of the adjusting portion and may engage with the outer thread, and wherein rotating the outer thread may prompt the adjusting portion to move in the axial (H) direction, and wherein as the predetermined pressure adjusting device moves towards the first rolling pieces, such movement would generate a predetermined pressure (Z) between the first inner slot and the outer slot as well as the first rolling pieces and between the second inner slot and the outer slot as well as the first rolling pieces.

3. The nut rotary ball screw as in claim 1, wherein two backflow holes, which extend axially through the nut portion, are provided on the nut portion.

4. The nut rotary ball screw as in claim 3, wherein the backflow element has several backflow slots, which connect with the load path and the backflow holes, and wherein a circulatory path is formed by the load path, backflow holes and backflow slots and the circulatory path has a plurality of second rolling pieces.

5. The nut rotary ball screw as in claim 1, wherein two holes, which are radially opposing each other, are provided on the predetermined pressure adjusting device and a positioning piece may be held in each of the two holes and friction would be generated by the contact between the positioning pieces and the outer thread.

6. The nut rotary ball screw as in claim 2, wherein two holes, which are radially opposing each other, are provided on the adjusting portion and a positioning piece may be held in each of the two holes and friction would be generated by the contact between the positioning pieces and the outer thread.

7. The nut rotary ball screw as in claim 2, wherein two backflow holes, which extend axially through the nut portion, are provided on the nut portion.

8. The nut rotary ball screw as in claim 7, wherein the backflow element has several backflow slots, which connect with the load path and the backflow holes, and wherein a circulatory path is formed by the load path, backflow holes and backflow slots and the circulatory path has a plurality of second rolling pieces.
